(19) United States
(12) Patent Application Publication
(10) Pub. No.: US 2007/0040027 A1
(43) Pub. Date: Feb. 22, 2007

(54) Method of confidential email voting using personal voting codes

(76) Inventor: Fernando Morales, Reston, VA (US)

Correspondence Address: Fernando Morales, 2231 Wakerobin Lane, Reston, VA, 20191, US

(21) Appl. No.: 11/492,820

(22) Filed: Jul. 26, 2006

Related U.S. Application Data
(60) Provisional application No. 60/706,351, filed on Aug. 8, 2005.

(51) Int. Cl. G07C 13/00

(52) U.S. Cl. 235/386; 705/12

(57) ABSTRACT

A method to prevent email voters from revealing their true choices by using personal voting codes (PVC) in casting their ballots, particularly email absentee ballots. In one embodiment of the invention, voters enter sequential numbers to fill-out the available alternatives for each question on the ballot; for example, Mr. Bush, 3; Mr. Edwards, 4; Mr. Buchanan, 5 . . . ” and so on. If bystanders are in the vicinity of the voter when the ballot is being completed, they would not be able to determine the voter's choice because they would be unable to discern the choice from the markings on the ballot; because of the use of personal voting codes, only the voter would know that the voter's candidate of choice is tagged with their PVC. In a particular example, the voter may have entered the number five (5) as a decision-making mark (a.k.a. PVC), which s/he later uses in the ballot to select the candidate of her/his choice (Mr. Buchanan in the example). After verifying, at the precinct from the information originally send by the voters, that the email unequivocally pertains to the legitimated voter, the election official would then decrypt the email, which contains the secret ballot. The election official would then, print the ballot and write on it the PVC number as it appears on the information originally sent by the voter. The ballots, with the PVC written on it and stapled with all audit trail documents, would then be dropped into the ballot box.

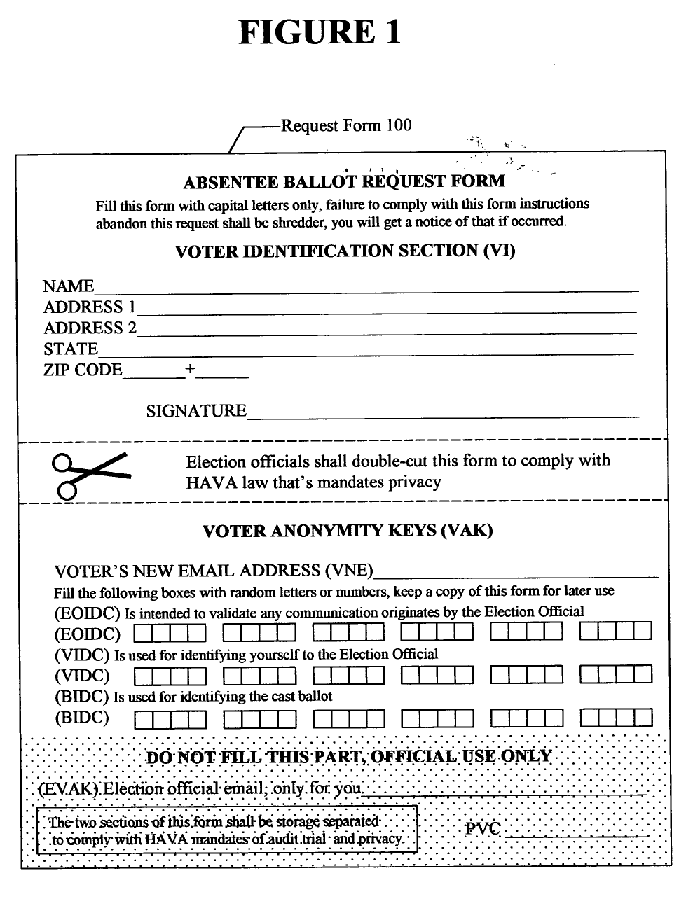

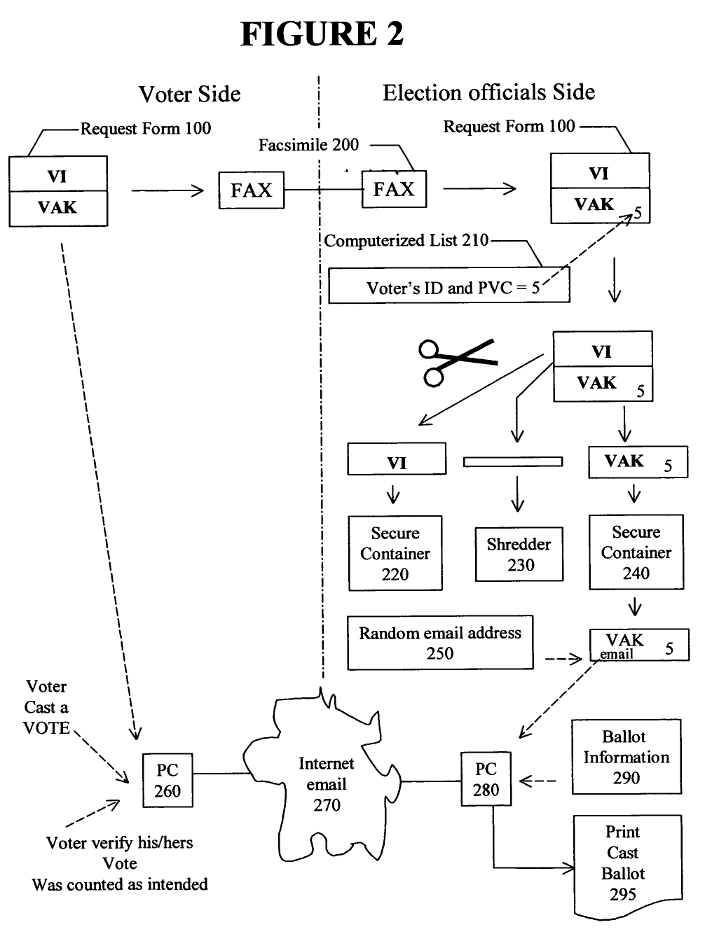

### CROSS-REFERENCE TO RELATED APPLICATION

This application claims priority under 35 U.S.C. §119(e) of U.S. Provisional Patent Application No. 60/706,351, filed on Aug. 8, 2005, the disclosure of which is hereby incorporated by reference thereto in its entirety.

### BACKGROUND OF THE INVENTION

1. Field of the Invention

The invention is directed to a method of confidential voting, particularly for voting using email in a computer connected to the internet or other network, while maintaining confidentiality, even in the presence of third parties while the ballot is completed.

More particularly, the invention is directed to a method of casting a ballot outside of the polling place.

2. Description of Background and Relevant Information

After more than a hundred years since the last revision of the Federal electoral law, the U.S. Congress passed The Help America Vote Act of 2002 (HAVA). The U.S. Election Assistance Commission (EAC) was established by HAVA. Central to its role, the Commission serves as a national clearinghouse and resource for information and review of procedures with respect to the administration of federal elections. According to the text of HAVA, the law was enacted to:
. . . establish a program to provide funds to states to replace punch card voting systems, to establish the Election Assistance Commission to assist in the administration of federal elections and to otherwise provide assistance with the administration of certain federal election laws and programs, to establish minimum election administration standards for states and units of local government with responsibility for the administration of federal elections, and for other purposes.
Excerpt from The Help America Vote Act of 2002

The Help America Vote Act of 2002 (HAVA) requires the Election Assistance Commission (EAC) among other things to generate technical guidance on the administration of federal elections and produce voluntary voting systems guidelines.

The Guidelines were developed by the HAVA-designated Technical Guidelines Development Committee (TGDC), comprised of technical experts, disability experts and election officials, and the National Institute of Standards and Technology (NIST).

The 2002 Help America Vote Act has given NIST a kev role in helping to realize nationwide improvements in voting systems by January 2006. To assist the Election Assistance Commission with the development of voluntary voting system guidelines, HAVA established the TGDC and directs NIST to chair the TGDC. NIST research activities include:
security of computers, computer networks, and computer data storage used in voting systems;
methods to detect and prevent fraud;
protection of voter privacy; and
the role of human factors in the design and application of voting systems, including assistive technologies for individuals with disabilities (including blindness) and varying levels of literacy.

On May 9, 2005, the Technical Guidelines Development Committee (TGDC) delivered an initial set of recommendations for new voluntary voting system guidelines (known as the May 9, 2005 Voluntary Voting System Guidelines (WSG) Version 1, Initial Report) to the Election Assistance Commission (EAC). While the EAC was reviewing these recommendations and before they made a determination as to what they will put forward as the EAC's proposed voting system guidelines for public comment. On May 31, 2005, the inventor of the invention disclosed herein hand-delivered a letter to the EAC General Counsel claiming that the WSG Section 2.2.7.4.3 is non-compliant with HAVA requirements of privacy by the statement “There is no practical means to prevent a voter from revealing an absentee paper ballot to others” if a practical means does exist, precisely to prevent voters from revealing their true choices. This letter describes the practical means that are disclosed herein.

The EAC's proposed guidelines (without the non-compliant statement) were posted in the Federal Register, and the EAC made the proposed guidelines a document available for download from their website.

EAC accepted comments on the Guidelines for 90 days. Among those comments the inventor of the present application submit on Aug. 31, 3006 title: “WSG is non-compliant with HAVA for assuming that there isn't a practical mean for counting millions of overseas votes which are currently unaccounted for in each election” which described the method describe in this application. Comments were posted on the website, submitted via email to votingsystemguidelines@eac.gov or mailed to: Voting System Guidelines Comments, U.S. Election Assistance Commission, 1225 New York Avenue, N.W., Suite 1100, Washington, DC 20005. The Guidelines were also available in hard copy and CD-ROM formats. Copies could be obtained by contacting EAC at 1-866-747-1471 or by visiting the EAC website at www.eac.gov.

At the conclusion of the public comment period and after the consideration of comments received, on Dec. 13, 2005, the EAC unanimously adopted the 2005 Voluntary Voting System Guidelines (WSG 2005), which they claim then will significantly increase security requirements for voting systems and expand access, including opportunities to vote privately and independently, for individuals with disabilities. On Jan. 13, 2006, the EAC posted the WSG 2005 without the non-compliant statement as follows:
The WSG 2005 defines privacy as the ability to prevent others from determining how an individual voted. (Seepage A-14 of the WSG 2005).

3.1.7 Privacy
The voting process shall preclude anyone else from determining the content of a voter's ballot, without the voters cooperation.
Discussion: Privacy ensures that the voter can make selections based solely on his her own preferences without intimidation or inhibition. Among other practices, this forbids the issuance of a receipt to the voter that would provide proof on how he or she voted. (See page 51 of the WSG 2005).
The guidelines will take effect in December 2007 (24 months), at which time voting systems will no longer be tested against the 2002 Voting System Standards (VSS) developed by the Federal Election Commission. All previous versions of national standards will become obsolete at that time.
The voluntary guidelines provide a set of specifications and requirements against which voting systems can be tested to determine if the systems provide all of the basic functionality, accessibility and security capabilities required of these systems. In addition, the guidelines establish evaluation criteria for the national certification of voting systems.
The guidelines update and augment the 2002 VSS, as required by HAVA, to address advancements in election practices and computer technologies. These guidelines are voluntary. States may decide to adopt them entirely or in part prior to the effective date. Currently, at least 39 states use the national guidelines in their voting system certification process.

During the 90-day public comment period, EAC received more than 6,000 comments on the proposed guidelines. Each comment was reviewed and considered by EAC in consultation with the National Institute of Standards and Technology (NIST) in the development of the final version (VVSG 2005).

HAVA Section 301 Voting Systems Standards are a Federal mandate to all the States on and after Jan. 1, 2006. HAVA Section 301(c)(2) includes a dynamic mandate designed to reach the state of the art, or level of excellence on protection of paper ballot voting systems.

For that reason at the time the EAC adopted the WSG (Dec. 13, 2005) without the statement (“There is no practical means to prevent a voter from revealing an absentee paper ballot to others”) the privacy protection that HAVA Section 301 (c)(2) granted to paper ballot voting systems, was gone as well to any other technology to vote out side the polling places, consistent with the invention disclosed and claimed herein.

The record shows as indisputable fact that the TGDC was unable to discover a solution to the lack of privacy on the absentee paper ballot voting systems. This fact clearly demonstrates that the solution described herein was not known nor obvious to experts, who were quite aware of U.S. Pat. No. 6,607,137 as early as the day they were appointed to serve on the TGDC by the EAC, and as the NIST record shows precisely from the inventor's communication to them, which can be found at the NIST website: www.vote.nist.gov/ECPosStat.htm

A review of numerous patents and published patent applications shows that only U.S. Pat. No. 6,607,137, the inventor of which is the inventor of the current subject matter, disclose how to achieve privacy when voting occurs with observers, but in no way explain how to achieve the same level of privacy protection using an email voting process. Thus this innovative concept to use personal voting codes described in consider the ballot as legitimate. We again recommend encrypting the reply message, this time using the VIDC as the key. A ballot cast in this manner would be practically impossible to intercept, decrypt/hack, and returned on time for counting. Even if that were possible, ignorance of the voter's PVC makes it impossible for the hacker to know how to vote for his/her preferred option.

6.—The EO Receives the Cast Ballots

At a given time, the EO will open each of the EVAK accounts previously assigned to VAKs as described in Step 4 above.

Using the VIDC, the EO will be able to identify and decrypt only the message that comes from the legitimate voter, then print the ballot and attach it to the VAK. The EO shall count the votes on each ballot by matching the PVC that was written on the VAK to the selected options. The EO shall report if more than one message was received on that EVAK account for further investigation of the fraudulent messages.

7.—The EO Posts Cast Ballots

An Internet site shall be created to publish all the cast ballots. The EO publishes the cast ballots on the website that was created for this purpose.

8.—The voter may claim discrepancies and/or anomalies

The voter uses his/her BIDC to locate his/hers ballot in the site created by Step 7 and verify that his/her votes were actually counted and that his/hers selections were not changed.

In the event that a voter finds a problem or anomaly in the voting process, he/she only needs to return the VAK portion of the OPBRF with an explanation (a secure mail service is recommended). To assist in the ensuing investigation, the voter should attach all email communication related to the event.

It is an object of the invention therefore to provide a method to vote with privacy in absentee voting by email.

It is an object of the invention therefore to provide a method to vote with privacy in early voting by email.

It is an object of the invention therefore to provide a method to vote with privacy in voting by email.

It is an object of the invention therefore to provide a method to vote with privacy without a booth.

It is an object of the invention therefore to provide a method to vote with privacy for people with vision disabilities.

It is an object of the invention therefore to provide a method to vote with privacy for people with motion disabilities.

It is an object of the invention therefore to provide the convenience to vote wherever they want, to all voters that are required by State law to vote at the polling place because was the only way to prevent vote treading, coercion or intimidation.

1. encrypting the ballot information, after the voter has indicated one or more voter choices with the voter's personal voting code, to further maintain secrecy of the ballot.

6. A voting method according to claim 5, wherein the ballot encryption key was created by the voter, the method further comprising:
determining, by an election official or designated precinct worker, the voter's personal voting code maintained in an electoral list;
adding, by the election official or designated worker, the voter's personal voting code on the information sent by the voter.
